(19) United States
(12) Patent Application Publication
(10) Pub. No.: US 2008/0013469 A1
(43) Pub. Date: Jan. 17, 2008

(54) Wireless System

(75) Inventor: David A. Eves, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,372

(22) PCT Filed: May 19, 2005
(86) PCT No.: PCT/IB05/51628

§ 371 Date: Nov. 20, 2006

(30) Foreign Application Priority Data
May 21, 2004 (GB) 0411319.7

(51) Int. Cl. H04L 12/56

(52) U.S. Cl. 370/310

(57) ABSTRACT

A wireless system comprises a plurality of wireless devices. Each wireless device includes a wireless transceiver, a storage device for storing data and a location-determining device. The system also comprises a data packet stored by a first wireless device, the data packet including location information. The first wireless device is arranged to transfer the data packet to a second wireless device according to the output of an algorithm. The algorithm uses the location information, the location of the first wireless device and the location of the second wireless device to generate its output.

This invention relates to a wireless system, a method of operating a wireless system, a wireless device and a method of operating a wireless device.

Many different types of wireless systems are in place around the world. A typical example of a wireless system is a mobile phone network, which comprises a series of base stations in logical cells and a large number of mobile phones that can communicate with each other and with wired networks via the base stations. There are also in existence shorter range wireless systems that are installed in office buildings and in homes, which comprise one or more beacons that communicate with devices such as personal computers and laptops.

There is also a desire to provide information via wireless systems that is localised to a particular area. International patent application publication WO 02/076039 discloses a beacon update mechanism. In the mechanism, a communications network comprises a plurality of beacons for transmitting data to mobile receivers within range, each beacon storing local data items for transmission to the mobile receivers, which is dependent on the location of the beacon. A central controller is provided for updating the local data items stored in the beacons. The central controller enables beacons to be identified, which require updating in response to a desired change in a local data item. This system uses a central controller that can manage the control and configuration and software running on the remote beacons. The central controller can efficiently monitor and control the content information running on each beacon to ensure the network is providing up-to-date alerts and messages to users. Such a system could be provided, for example, in an airport or shopping centre, where providing highly localised information to users is advantageous.

However all known localised wireless systems require the installation of beacons and the provision of a relatively sophisticated wired network connecting the beacons to some sort of central server. This makes such systems expensive to install and in some complicated structures and environments it is not possible to install a new network of beacons.

It is therefore an object of the invention to improve upon the known art.

According to a first aspect of the present invention, there is provided a wireless system comprising a plurality of wireless devices, each wireless device including a wireless transceiver, a storage device for storing data and a location-determining device, wherein the wireless system further comprises a data packet stored by a first wireless device, the data packet including location information, and the first wireless device being arranged to transfer the data packet to a second wireless device according to the output of an algorithm, the algorithm using the location information, the location of the first wireless device and the location of the second wireless device.

According to a second aspect of the present invention, there is provided a method of operating a wireless system, the wireless system comprising a plurality of wireless devices, each wireless device including a wireless transceiver, a storage device for storing data and a location-determining device, and a data packet stored by a first wireless device, the data packet including location information, the method comprising the step of transferring the data packet from the first wireless device to a second wireless device according to the output of an algorithm, the algorithm using the location information, the location of the first wireless device and the location of the second wireless device.

According to a third aspect of the present invention, there is provided a wireless device including a wireless transceiver, a storage device for storing data, a location-determining device, and a data packet stored by the storage device, the data packet including location information, wherein the wireless device is arranged to transfer the data packet to a second wireless device according to the output of an algorithm, the algorithm using the location information, the location of the wireless device and the location of the second wireless device.

According to a fourth aspect of the present invention, there is provided a method of operating a wireless device, the wireless device including a wireless transceiver, a storage device for storing data, a location-determining device, and a data packet stored by the storage device, the data packet including location information, the method comprising the step of transferring the data packet to a second wireless device according to the output of an algorithm, the algorithm using the location information, the location of the wireless device and the location of the second wireless device.

Owing to the invention, it is possible to provide a wireless network that provides information that is localised, without the need to install a network of beacons to provide the network. Information that is needed for a locality is held by a wireless device in that location as a data packet and is passed to a second wireless device when the first wireless device leaves the locality.

Advantageously, the first wireless device is also arranged to store the data packet if no second wireless device is within range and to transfer the data packet to a second wireless device when the second wireless device is within range. Therefore, if there is no second device within range, when the first device leaves the locality, the first device will continue to store the data packet, and pass on the information when a second device does come within range. This ensures that data is not lost, but is maintained by the devices in the system. The data packet is passed to a second device when that is a better candidate for re-locating the data into the packet's proper locality.

Preferably the data packet includes a header, and the first wireless device is arranged to communicate the header to any wireless device in range. The header will typically relate to the contents of the data packet, and will be a summary of the information in the data packet. In an alternative arrangement, the first wireless device is arranged to access profile information stored on a wireless device in range and to communicate the header to the wireless device in range according to the contents of the profile information. Advantageously, the first wireless device is also arranged to communicate the data packet to any wireless device that requests the data packet. By communicating the header to the other devices in the locality of the first device, those other devices can find out about the existence of the data packet and, if desired, they can request a copy of the data packet.

The system assumes a highly dynamic and fairly well populated physical space, a good example being a motorway. Within that space the population of devices (in this case the cars) each have a storage capability, but rather than associating data with a particular unit of storage, the data is associated with a location in the space. The data is then held in memory that currently occupies the space—if that memory then leaves the location associated with the data it is passed on to another suitable carrier. Heuristics are used to choose the best carrier available i.e. a vehicle moving into the space rather than away from it.

By associating data with a spatial location this can allow context sensitive information to be held while using a high dynamic storage media. For example the cars could hold the route information for that particular stretch of road or adverts for special offers at a local service station. Other possibilities exist for moving the data to different contexts using the dynamics of the storage media, for example, propagating congestion warnings along a road from the source.

Storage capacity and accuracy of the network will increase directly with the level of population, which should fit well to the amount of data needing to be stored. Storage zones may need to grow as the population becomes more distributed and carriers find it harder to pass on data. Additional heuristics will be needed to avoid lost data if carriers cannot find an alternative before moving out of zone, for example, using parallel storage or allowing data to move out of location briefly until a new carrier is found.

Mobile phones can be another carrier medium in, for example, a busy shopping mall.

The resolution of the spatial storage space and the capacity are both going to be governed by a combination of the range and quality of communication between individual storage nodes and also the level of population. Indeed communication range may largely define size of memory zones. The system must also be flexible enough to prevent data loss, for example, if a locality becomes unpopulated for a period. In a case such as this data is preserved in nearby zones and is arranged to propagate back when possible.

Embodiments of the present invention will now be described, by way of example only, with reference to the accompanying drawings, in which:—

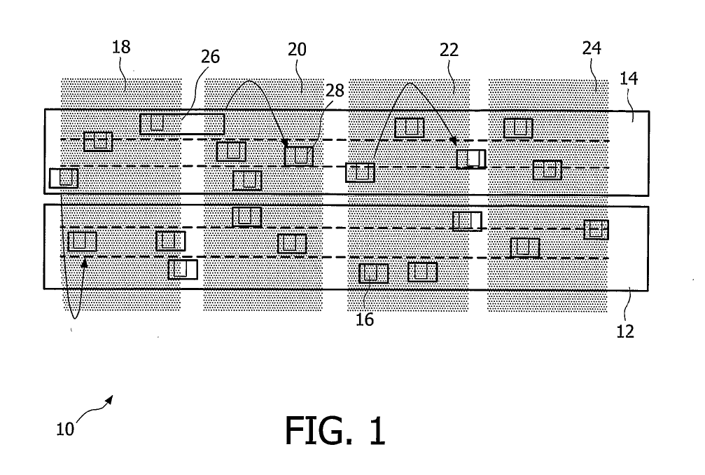

FIG. 1 is a schematic diagram of a road, split into a number of localities,

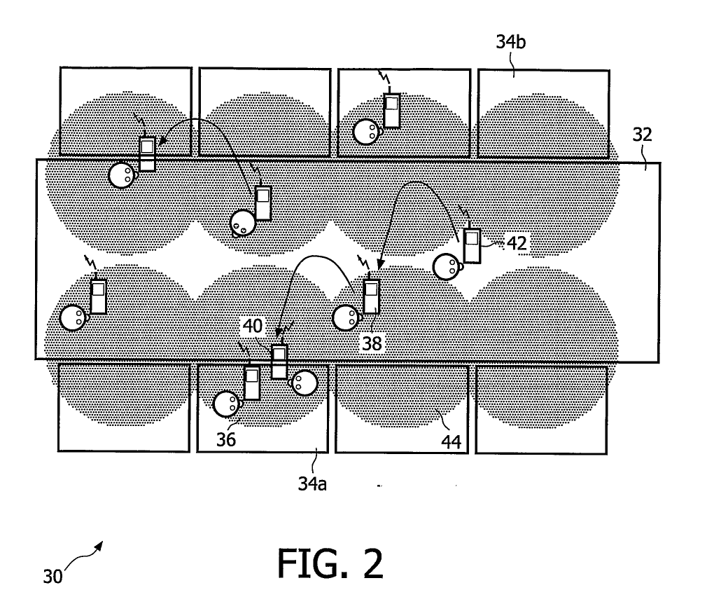

FIG. 2 is a schematic diagram similar to FIG. 1 of a shopping centre,

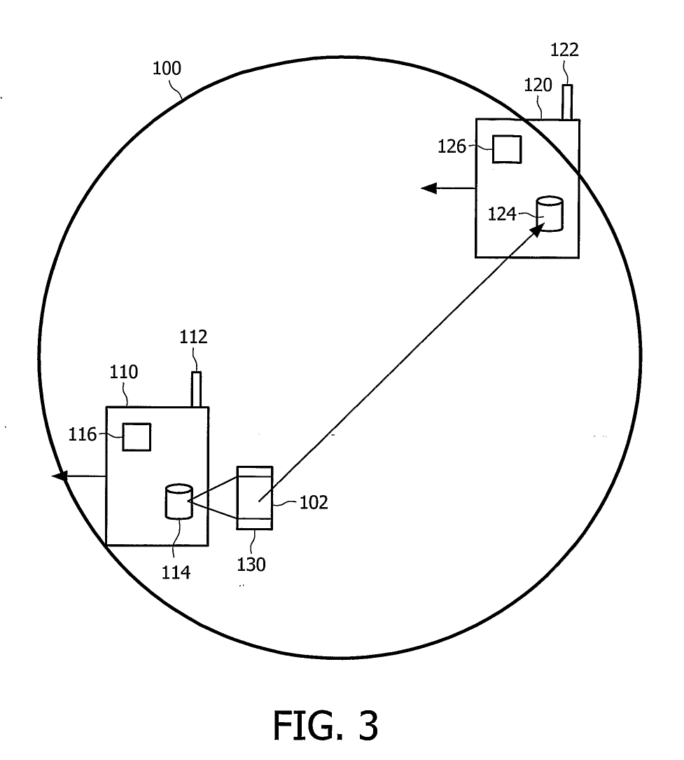

FIG. 3 is a schematic diagram of a wireless system, suitable for use in the environments illustrated in FIGS. 1 and 2,

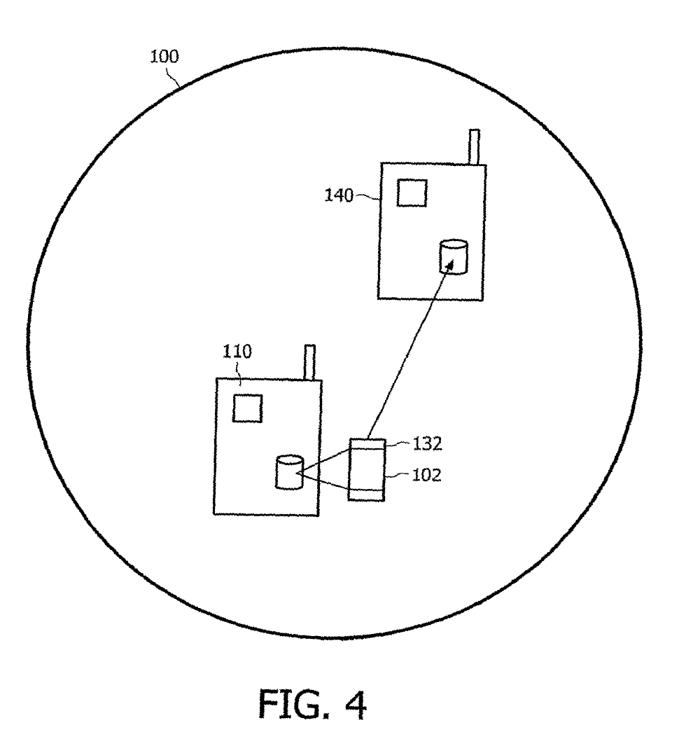

FIG. 4 is a schematic diagram of the wireless system of FIG. 3 in a second mode of operation, and

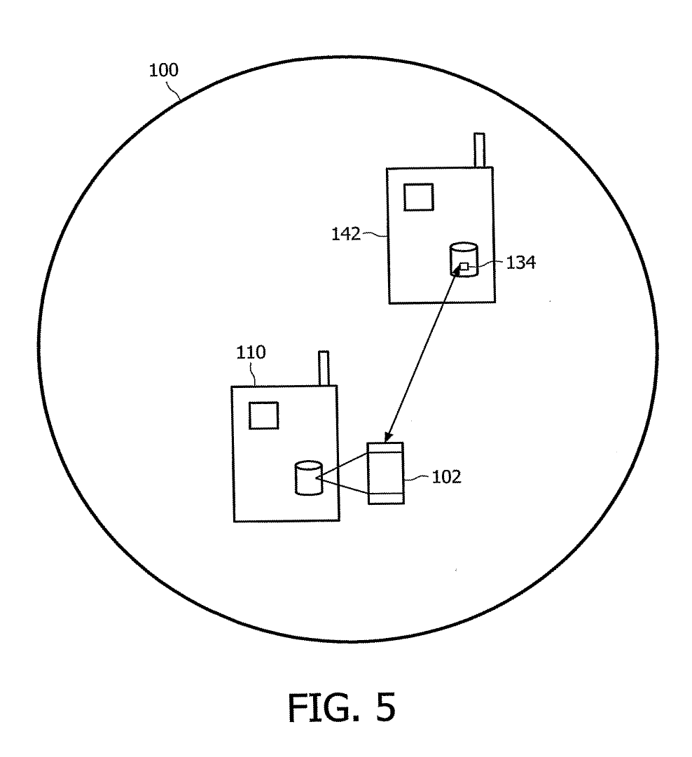

FIG. 5 is a schematic diagram of the wireless system of FIG. 3 in a third mode of operation.

FIG. 1 shows a road 10 with carriageways 12 and 14. Each carriageway 12 and 14 carry vehicles 16 that travel along the road 10. The road 10 will typically be a motorway that carries a reasonably large amount of traffic. An ad hoc wireless network can be created on this road 10, if each vehicle 16 is considered to be a wireless device in the network. Specific localities 18, 20, 22 and 24 are defined as logical networks of the devices within them. Each locality is typically several hundred metres in length (the Figure is not to scale) and the purpose of the network is to preserve information in a locality without the need for local beacons and a wired network connecting to the beacons. As a device (vehicle 26 for example) leaves the locality 20 it passes the data packet that it is storing to another vehicle 28 that is just entering the locality 20. This is discussed in more detail with reference to FIG. 3.

FIG. 2 illustrates a second environment that is also suitable for setting up an ad hoc network. A shopping centre 30 is made up of a central concourse 32 and a number of shops 34. As in FIG. 1, a number of logical localities are defined, an example of which is the circle 36 that defines a locality including the shop 34a and a portion of the concourse in front of the shop 34a. As before, a data packet is maintained within the locality 36 by being passed from a first mobile device 38 to a second mobile device 40. The device 38 is also in receipt of a data packet from another device 42 that relates to the locality 44. The user of the mobile device 38 will have access to a data packet that is stored on the device 42, the data packet being relevant to the locality in which the user is presently located.

The wireless systems of FIGS. 1 and 2 are shown in a simplified form in FIG. 3. The circle 100 identifies a single logical locality and a data packet 102 is associated with that locality 100. An example of such an arrangement would be a shop with the data packet containing details of current special offers available in that shop. The wireless system of FIG. 3 comprises a plurality of wireless devices 110 and 120, each wireless device 110 and 120 including a wireless transceiver 112 and 122, a storage device 114 and 124 for storing data and a location-determining device 116 and 126. The location-determining devices 116 and 126 are GPS units within the devices that can accurately pinpoint the position of each device.

The wireless system also includes the data packet 102 stored by the first wireless device 110, the data packet 102 including location information 130. The first wireless device 110 is arranged to transfer the data packet 102 to the second wireless device 120 according to the output of an algorithm. The algorithm uses the location information 130, the location of the first wireless device 110 and the location of the second wireless device 120 to determine when to transfer the data packet 102 to the second device 120. The location information 130 that is included within the data packet 102 is the locality in which the data packet 102 is to be maintained. This can be a set of GPS coordinates or could be a single coordinate with a distance measurement defining a circle.

A simple form of the algorithm that determines when to transfer the data packet 102 is based upon distance from the centre of the locality 100. When the first wireless device 110 is more than 75% of the radius from the centre of the locality 100 then it will transfer the data packet 102 to a second device 120 that is less than 75% of the radius from the centre of the locality 100. In FIG. 3, the algorithm that is used is also based upon the movement of the wireless devices 110 and 120, which can be deduced from rapid recalculation of the positions of the devices 110 and 120. The output of the algorithm is used to transfer the data packet from the first wireless device 110 as that device is moving out of the locality 100, and is passed to the second device 120 as that device 120 enters the locality 100. As will be realised there are many different positions and directions of the various wireless devices, essentially the algorithm is determining if the current device that is storing the data packet 102 is leaving the locality 100 and passing the data packet 102 to a second device 120.

The first wireless device 110 is also arranged to store the data packet 102 if no second wireless device is within range. If the device 100 is leaving the locality 100 and the algorithm cannot find a device in range to receive the data packet 102 then the device 110 will continue to store the data packet 102 in order that the data is not lost. The wireless device 110 is further arranged to transfer the data packet 102 to a second wireless device when the second wireless device is within range. So, for example, if the device 110 leaves the locality 100 without transferring the data packet 102, it will nevertheless transfer the data packet if subsequently a device comes into range that is in the locality 100 or is moving towards that locality.

FIG. 4, which is a view similar to FIG. 3, shows the first device 110, which is storing the data packet 102. The data packet 102 includes a header 132, and the first wireless device 110 is arranged to communicate the header 132 to any wireless device (an example of which is shown as 140) in range. The header 132 includes details of the contents of the data packet 102. The first wireless device 110 is also arranged to communicate the data packet 102 to any wireless device that requests the data packet 102. In this way other wireless devices in the locality 100 are made aware of the existence and content of the data packet 102 and can request a copy of the data packet. The user of the mobile device 140 will receive a message along the lines of “Special Offer in CD shop—press green for more details”. This is the content of the header 132 that is received by the device 140, and by pressing the green button on their mobile device 140, the user makes a request for the further information, and the data packet is requested by the device 140 and is sent to that device 140. The first mobile device 110 still maintains its role as the holder of the data packet 102 and will transfer this (rather than copy it) to another device according to the output of the original algorithm that is continuing to operate in the background.

In FIG. 5, the first wireless device 110 is arranged to access profile information 134 stored on a wireless device 142 in range and to communicate the header 132 to the wireless device 142 in range according to the contents of the profile information 134. In this mode of operation, which is similar to that shown and described with reference to FIG. 4, profile information 134 stored on the wireless device 142 is first checked to see if the user of the mobile device 142 is likely to be interested in the data packet 132. If there is a match between the header 132 and the profile information 134 then the header 132 is transferred to the device 142. The first wireless device 110 is arranged to then communicate the data packet 102 to the wireless device 142 if there is a request for the data packet 102.

To create a wireless network as described above, an initialisation phase is required. A number of different methods are possible to achieve this. A first possibility is for all of the data packets to be sent to a single wireless device that is in at least one of the localities. This can be achieved by, for example, if the wireless devices are mobile phones, making a single call to a mobile phone in one of the localities. This mobile phone will receive all the data packets and the packets will move from this phone according to a populating algorithm through other wireless devices until they reach the locality that is detailed in the location information in each data packet. A second possibility is for there to be a single beacon at an entry point to the localities, for example, at the entrance to a shopping centre. As mobile devices pass the beacon they receive one or more data packets relevant to one or more localities and the data packets are populated to the correct area by the users of the devices moving to the correct locality.

1. A wireless system comprising a plurality of wireless devices, each wireless device including a wireless transceiver, a storage device for storing data and a location-determining device, wherein the wireless system further comprises a data packet stored by a first wireless device, the data packet including location information, and the first wireless device being arranged to transfer the data packet to a second wireless device according to an output of an algorithm, the algorithm using the location information, the location of the first wireless device and the location of the second wireless device.

2. A wireless system according to claim 1, wherein the first wireless device is also arranged to store the data packet if no second wireless device is within range and to transfer the data packet to a second wireless device when the second wireless device is within range.

3. A wireless system according to claim 1, wherein the data packet includes a header, and the first wireless device is arranged to communicate the header to any wireless device in range.

4. A wireless system according to claim 1, wherein the data packet includes a header, and the first wireless device is arranged to access profile information stored on a wireless device in range and to communicate the header to the wireless device in range according to contents of the profile information.

5. A wireless system according to claim 3, wherein the first wireless device is also arranged to communicate the data packet to any wireless device that requests the data packet.

6. A method of operating a wireless system, the wireless system comprising a plurality of wireless devices, each wireless device including a wireless transceiver, a storage device for storing data and a location-determining device, and a data packet stored by a first wireless device, the data packet including location information, the method comprising the step of transferring the data packet from the first wireless device to a second wireless device according to an output of an algorithm, the algorithm using the location information, the location of the first wireless device and the location of the second wireless device.

7. A method according to claim 6, and further comprising storing the data packet if no second wireless device is within range and transferring the data packet to a second wireless device when the second wireless device is within range.

8. A method according to claim 6, wherein the data packet includes a header, and the method further comprises communicating the header to any wireless device in range.

9. A method according to claim 6, wherein the data packet includes a header, and the method further comprises accessing profile information stored on a wireless device in range and communicating the header to the wireless device in range according to contents of the profile information.

10. A method according to claim 8, wherein the method further comprises communicating the data packet to any wireless device that requests the data packet.

11. A wireless device including a wireless transceiver, a storage device for storing data, a location-determining device, and a data packet stored by the storage device, the data packet including location information, wherein the wireless device is arranged to transfer the data packet to a second wireless device according to an output of an algorithm, the algorithm using the location information, the location of the wireless device and the location of the second wireless device.

12. A wireless device according to claim 11, wherein the wireless device is also arranged to store the data packet if no second wireless device is within range and to transfer the data packet to a second wireless device when the second wireless device is within range.

13. A wireless device according to claim 11, wherein the data packet includes a header, and the device is arranged to communicate the header to any wireless device in range.

14. A wireless device according to claim 11, wherein the data packet includes a header, and the device is arranged to access profile information stored on a wireless device in range and to communicate the header to the wireless device in range according to contents of the profile information.

15. A wireless device according to claim 13, wherein the wireless device is also arranged to communicate the data packet to any wireless device that requests the data packet.

16. A method of operating a wireless device, the wireless device including a wireless transceiver, a storage device for storing data, a location-determining device, and a data packet stored by the storage device, the data packet including location information, the method comprising the step of transferring the data packet to a second wireless device according to an output of an algorithm, the algorithm using the location information, the location of the wireless device and the location of the second wireless device.

17. A method according to claim 16, and further comprising storing the data packet if no second wireless device is within range and transferring the data packet to a second wireless device when the second wireless device is within range.

18. A method according to claim 16, wherein the data packet includes a header, and the method further comprises communicating the header to any wireless device in range.

19. A method according to claim 16, wherein the data packet includes a header, and the method further comprises accessing profile information stored on a wireless device in range and communicating the header to the wireless device in range according to contents of the profile information.

20. A method according to claim 18, wherein the method further comprises communicating the data packet to any wireless device that requests the data packet.
